(19) United States
(12) Patent Application Publication
(10) Pub. No.: US 2013/0057830 A1
(43) Pub. Date: Mar. 7, 2013

(54) STEREOSCOPIC DISPLAY SYSTEM AND SCREEN MODULE

(71) Applicants: Chao-Hsu Tsai, Hsinchu City (TW); Chang-Shuo Wu, New Taipei City (TW); Chang-Ying Chen, Kaohsiung City (TW)

(72) Inventors: Chao-Hsu Tsai, Hsinchu City (TW); Chang-Shuo Wu, New Taipei City (TW); Chang-Ying Chen, Kaohsiung City (TW)

(73) Assignee: INDUSTRIAL TECHNOLOGY RESEARCH INSTITUTE, Hsinchu (TW)

(21) Appl. No.: 13/354,287

(22) Filed: Jan. 19, 2012

(30) Foreign Application Priority Data
Sep. 7, 2011 (TW) 100132279

(51) Int. Cl. G02B 27/22; G03B 21/60

(52) U.S. Cl. 353/7; 359/458

(57) ABSTRACT

A stereoscopic display system including a plurality of image projection apparatuses and a screen module is provided. The image projection apparatuses are configured to respectively project a plurality of image beams, and the screen module is disposed on transmission paths of the image beams. The screen module includes an optical diffusion layer, a first image guiding plate, and a second image guiding plate. The first image guiding plate is disposed between the image projection apparatuses and the optical diffusion layer, and includes a plurality of first optical structures arranged in period. The optical diffusion layer is disposed between the first image guiding plate and the second image guiding plate. The second image guiding plate includes a plurality of second optical structures arranged in period. A screen module is also provided.

### CROSS-REFERENCE TO RELATED APPLICATION

This application claims the priority benefit of Taiwan application serial no. 100132279, filed on Sep. 7, 2011. The entirety of the above-mentioned patent application is hereby incorporated by reference herein and made a part of this specification.

### BACKGROUND

1.Technical Field

The disclosure relates to a display system and an optical module. Particularly, the disclosure relates to a stereoscopic display system and a screen module.

2. Related Art

With development of display technology, displays having better image quality, richer color performance and better performance effect are continuously developed. In recent years, a stereoscopic display technology has extended from cinema applications to home display applications. Since a key technique of the stereoscopic display technology is to ensure a left eye and a right eye of a user to respectively view left-eye images and right-eye images of different viewing angles, according to the conventional stereoscopic display technology, the user generally wears a special pair of glasses to filter the left-eye images and the right-eye images.

However, to wear the special pair of glasses may generally cause a lot of inconveniences, especially for a nearsighted or farsighted user who has to wear a pair of glasses with corrected vision, the extra pair of special glasses may cause discomfort and inconvenience. Therefore, a naked-eye stereoscopic display technology becomes one of the key focuses in researches and developments. A conventional naked-eye stereoscopic display is suitable for producing a plurality of viewing zones in space, and displays images of different viewing angles at different viewing zones. When the left eye and the right eye of the user are respectively located at two adjacent viewing zones, the user can view two images of different viewing angles. In this way, the two images of different viewing angles can be combined into a stereoscopic image in user's brain.

The naked-eye stereoscopic display is designed based on viewing zones, which may achieve an optimal viewing effect at designed view points. However, in case the viewers are at places other than the designed view points, the viewing stereoscopic effect is obviously decreased, and a spatial position of an object is varied along with positions of the viewer, and such characteristic may cause uncomfortable and unnatural feelings when viewing.

### SUMMARY

An exemplary embodiment provides a stereoscopic display system including a plurality of image projection apparatuses and a screen module. The image projection apparatuses are configured to respectively project a plurality of image beams, and the screen module is disposed on transmission paths of the image beams. The screen module includes an optical diffusion layer, a first image guiding plate, and a second image guiding plate. The optical diffusion layer is disposed on the transmission paths of the image beams. The first image guiding plate is disposed on the transmission paths of the image beams, and is disposed between the image projection apparatuses and the optical diffusion layer. The first image guiding plate includes a plurality of first optical structures arranged in period for projecting the image beams to different positions on the optical diffusion layer. The second image guiding plate is disposed on the transmission paths of the image beams, and the optical diffusion layer is disposed between the first image guiding plate and the second image guiding plate. The second image guiding plate includes a plurality of second optical structures arranged in period for respectively guiding the image beams projected on the optical diffusion layer by different image projection apparatuses to a plurality of different directions, where after a plurality of different partial beams of the image beam projected by the same image projection apparatus are respectively guided by the second optical structures, the partial beams are substantially parallel to each other on at least one cross-section.

An exemplary embodiment provides a screen module including an optical diffusion layer, a first image guiding plate, and a second image guiding plate. The first image guiding plate is disposed at one side of the optical diffusion layer, and includes a plurality of first optical structures arranged in period. The second image guiding plate is disposed at another side of the optical diffusion layer, and the optical diffusion layer is disposed between the first image guiding plate and the second image guiding plate. The second image guiding plate includes a plurality of second optical structures arranged in period, where a pitch of the second optical structures is greater than a pitch of the first optical structures.

An exemplary embodiment provides a stereoscopic display system including a plurality of image projection apparatuses and a screen module. The image projection apparatuses are configured to respectively project a plurality of image beams, and the screen module is disposed on transmission paths of the image beams. The screen module includes a first image guiding means, an optical diffusion means, and a second image guiding means. The first image guiding means is for respectively projecting the image beams to different positions. The optical diffusion means is for diffusing the image beams projected by the first image guiding means. The second image guiding plate is for respectively guiding the image beams projected by different image projection apparatuses and diffused by the optical diffusion means to a plurality of different directions, where after a plurality of different partial beams of the image beam projected by the same image projection apparatus are guided by the second image guiding means, the partial beams are substantially parallel to each other on at least one cross-section.

In order to make the aforementioned and other features and advantages of the disclosure comprehensible, several exemplary embodiments accompanied with figures are described in detail below.

### BRIEF DESCRIPTION OF THE DRAWINGS

The accompanying drawings are included to provide a further understanding of the disclosure, and are incorporated in and constitute a part of this specification. The drawings illustrate embodiments of the disclosure and, together with the description, serve to explain the principles of the disclosure.

FIG. 1A is a top view of a stereoscopic display system according to an exemplary embodiment.

FIG. 1B is a partial top view of the stereoscopic display system of FIG. 1A.

FIG. 1C is a front view of a first image guiding plate of FIG. 1A.

FIG. 2 is a schematic diagram of a plurality of light beams formed in space by the stereoscopic display system of FIG. 1.

FIG. 3A is a partial top view of a stereoscopic display system according to another exemplary embodiment.

FIG. 3B is a front view of a first image guiding plate of FIG. 3A.

FIG. 4 is a partial top view of a stereoscopic display system according to still another exemplary embodiment.

FIG. 5 is a partial top view of a stereoscopic display system according to yet another exemplary embodiment.

FIG. 6 is a back view of a stereoscopic display system according to another exemplary embodiment.

FIG. 7 is a three-dimensional view of a stereoscopic display system according to still another exemplary embodiment.

FIG. 8 is a three-dimensional view of a stereoscopic display system according to still another exemplary embodiment.

FIG. 9 is a partial top view of a stereoscopic display system according to still another exemplary embodiment.

FIG. 10 is a partial top view of a stereoscopic display system according to still another exemplary embodiment.

### DETAILED DESCRIPTION OF DISCLOSED EMBODIMENTS

Below, exemplary embodiments will be described in detail with reference to accompanying drawings so as to be easily realized by a person having ordinary knowledge in the art. The inventive concept may be embodied in various forms without being limited to the exemplary embodiments set forth herein. Descriptions of well-known parts are omitted for clarity, and like reference numerals refer to like elements throughout.

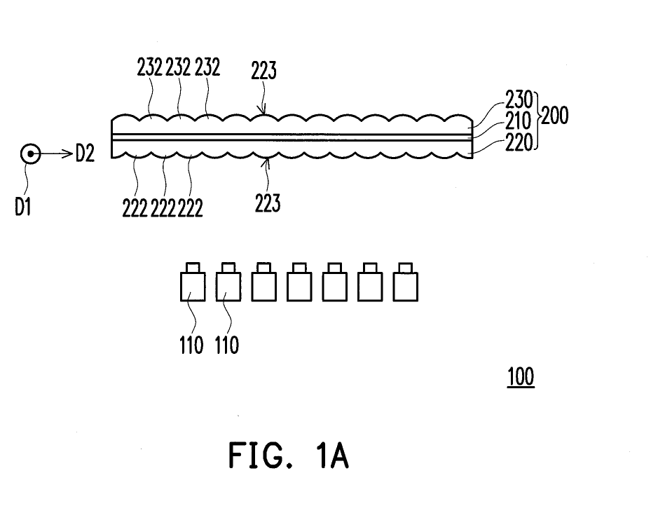

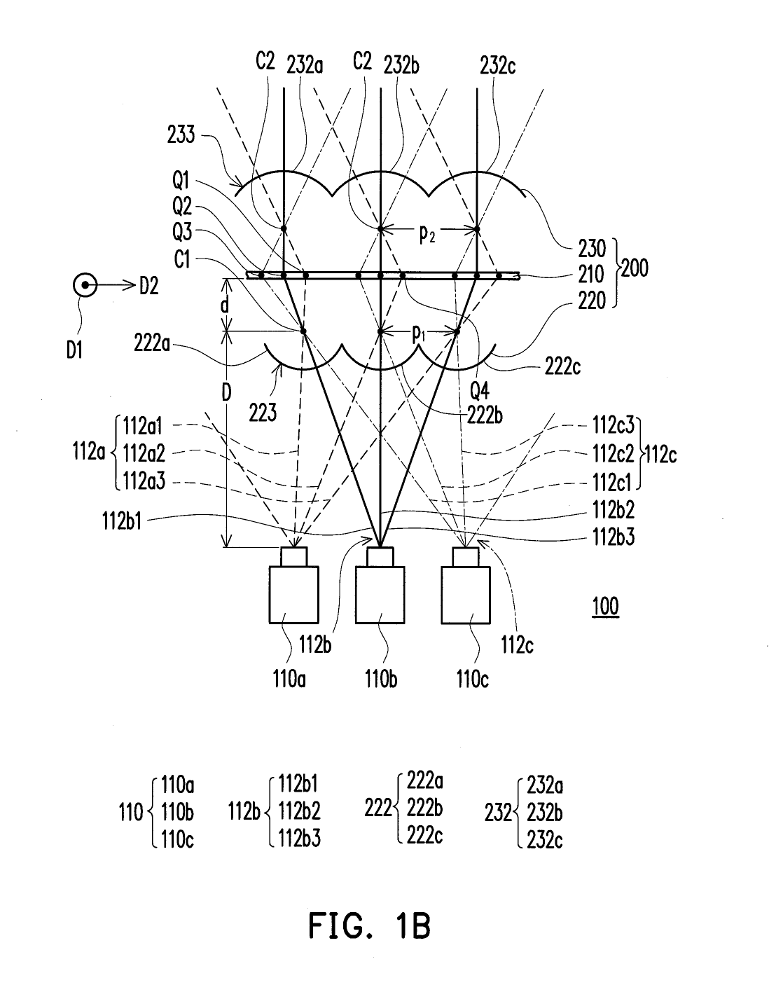

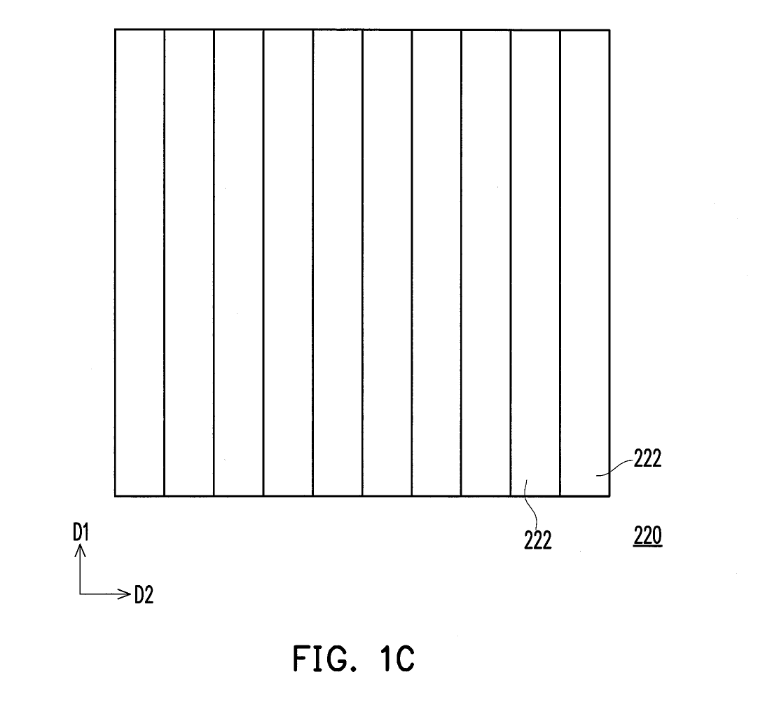

FIG. 1A is a top view of a stereoscopic display system according to an exemplary embodiment. FIG. 1B is a partial top view of the stereoscopic display system of FIG. 1A, and FIG. 1C is a front view of a first image guiding plate of FIG. 1A. Referring to FIG. 1A-FIG. 1C, the stereoscopic display system 100 of the embodiment includes a plurality of image projection apparatuses 110 and a screen module 200. The image projection apparatuses 110 are configured to respectively project a plurality of image beams 112a, 112b and 112c (shown in FIG. 1B), and the screen module 200 is disposed on transmission paths of the image beams 112a, 112b and 112c. The screen module 200 includes a first image guiding means, an optical diffusion means, and a second image guiding means. The first image guiding means is for respectively projecting the image beams 112a, 112b and 112c to different positions. The optical diffusion means is for diffusing the image beams 112a, 112b and 112c projected by the first image guiding means. The second image guiding plate is for respectively guiding the image beams 112a, 112b and 112c projected by different image projection apparatuses 110 and diffused by the optical diffusion means to a plurality of different directions, where after a plurality of different partial beams 112a1-112a3, 112b1-112b3, or 112c1-112c3 (shown in FIG. 1B) of the image beam 112a, 112b, or 112c projected by the same image projection apparatus 110 (e.g. 110a, 110b, or 110c) are respectively guided by the second image guiding means, the partial beams 112a1-112a3, 112b1-112b3, or 112c1-112c3 are substantially parallel to each other on at least one cross-section (for example, a figure plane of FIG. 1B). That is, the partial beams 112a1, 112a2, and 112a3 are substantially parallel to each other on at least one cross-section, the partial beams 112b1, 112b2, and 112b3 are substantially parallel to each other on at least one cross-section, and the partial beams 112c1, 112c2, and 112c3 are substantially parallel to each other on at least one cross-section. In the present embodiment, the screen module 200 includes an optical diffusion layer 210, a first image guiding plate 220 and a second image guiding plate 230. In the present embodiment, the first image guiding means can be implemented by the first image guiding plate 220, the optical diffusion means can be implemented by the optical diffusion layer 210, and the second image guiding means can be implemented by the second image guiding plate 230.

In the present embodiment, the optical diffusion layer 210 is disposed on transmission paths of the image beams 112a, 112b and 112c. The first image guiding plate 220 is disposed on the transmission paths of the image beams 112a, 112b and 112c, and is located between the image projection apparatuses 110 and the optical diffusion layer 210. The first image guiding plate 220 includes a plurality of first optical structures 222 arranged in period for projecting the image beams 112a, 112b and 112c to different positions on the optical diffusion layer 210. The second image guiding plate 230 is disposed on the transmission paths of the image beams 112a, 112b and 112c, and the optical diffusion layer 210 is disposed between the first image guiding plate 220 and the second image guiding plate 230. The second image guiding plate 230 includes a plurality of second optical structures 232 arranged in period for respectively guiding the image beams 112a, 112b and 112c projected on the optical diffusion layer 210 by different image projection apparatuses 110 to a plurality of different directions, where after the different partial beams 112a1-112a3, 112b1-112b3, or 112c1-112c3 of the image beams 112a, 112b, or 112c projected by the same image projection apparatus 110 (e.g. 110a, 110b, or 110c) are respectively guided by the second optical structures 232, the partial beams 112a1-112a3, 112b1-112b3, or 112c1-112c3 are substantially parallel to each other on at least one cross-section (for example, the figure plane of FIG. 1B). That is, the partial beams 112a1, 112a2, and 112a3, are substantially parallel to each other on at least one cross-section, the partial beams 112b1, 112b2, and 112b3 are substantially parallel to each other on at least one cross-section, and the partial beams 112c1, 112c2, and 112c3 are substantially parallel to each other on at least one cross-section.

In the present embodiment, a pitch of the second optical structures 232 is greater than a pitch of the first optical structures 222. Moreover, in the present embodiment, the pitch of the first optical structures 222 is, for example, p₁, the pitch of the second optical structures 232 is, for example, p₂, a distance between the first optical structures 222 and the optical diffusion layer 210 is d, a distance between the image projection apparatuses 110 and the first optical structures 222 along a direction perpendicular to the optical diffusion layer 210 is D, and the stereoscopic display system 100 of the embodiment is substantially complied with a following equation:

p₂=(1+d/D)p₁

In detail, in the present embodiment, the first image guiding plate 220 is, for example, a lenticular plate, and each of the first optical structures 222 is, for example, a lenticular lens. Each of the first optical structures 222 extends along a first direction D1, and the first optical structures 222 are arranged along a second direction D2. Moreover, in the present embodiment, the second image guiding plate 230 is, for example, a lenticular plate, and each of the second optical structures 232 is, for example, a lenticular lens. Each of the second optical structures 232 extends along the first direction D1, and the second optical structures 232 are arranged along the second direction D2. In the present embodiment, the lenticular lens refers to a lens having a surface curved along one direction and non-curved along another perpendicular direction. For example, in the present embodiment, the surface of the first optical structure 222 and the surface of the second optical structure 232 are not curved along the first direction D1, and are curved along the second direction D2, where the first direction D1 is substantially perpendicular to the second direction D2 in this embodiment. However, in other embodiments, the first direction D1 can be non-perpendicular to the second direction D2. In the present embodiment, the direction (the second direction D2) along which the first optical structures 222 present periodicity is substantially the same to the direction (the second direction D2) along which the second optical structures 232 present periodicity. Moreover, in the present embodiment, an arranging direction (for example, the second direction D2) of the image projection apparatuses 110 is substantially parallel to the direction (the second direction D2) along which the first optical structures 222 present periodicity. In other embodiments, the stereoscopic display system 100 is substantially complied with p₂=N(1+d/D)p₁, or substantially complied with p₂=(1+d/D)p₁/N, where N is a positive integer.

In the present embodiment, each of the first optical structures 222 (i.e. the lenticular lens) has a cylindrical surface 223, the aforementioned distance d is a distance between a center of curvature C1 of each of the cylindrical surfaces 223 and the optical diffusion layer 210, the aforementioned distance D is a distance between the image projection apparatuses 110 and the center of curvature C1 of the cylindrical surfaces 223 along a direction perpendicular to the optical diffusion layer 210, and p₂ is substantially equal to (1+d/D)p₁.

Referring to FIG. 1B, in the present embodiment, after the image beams 112a, 112b and 112c respectively projected by the image projection apparatuses 110a, 110b and 110c respectively enter the first optical structures 222a, 222b and 222c, each of the first optical structures 222a, 222b and 222c respectively projects the image beams 112a, 112b and 112c projected thereon to three different positions on the optical diffusion layer 210 (for example, the optical structure 222a respectively projects the image beams 112a, 112b and 112c projected thereon to three different positions Q1, Q2 and Q3 on the optical diffusion layer 210). For example, the partial beam 112a1 of the image beam 112a projected to the first optical structure 222a is projected to the position Q1 on the optical diffusion layer 210, and a transmission path of the partial beam 112a1 shown in FIG. 1B passing through the center of curvature C1 of the first optical structure 222a is taken as an example. Moreover, the partial beam 112b1 of the image beam 112b projected to the first optical structure 222a is projected to the position Q2 on the optical diffusion layer 210, and a transmission path of the partial beam 112b1 shown in FIG. 1B passing through the center of curvature C1 of the first optical structure 222a is taken as am example. In addition, the partial beam 112c1 of the image beam 112c projected to the first optical structure 222a is projected to the position Q3 on the optical diffusion layer 210, and a transmission path of the partial beam 112c1 shown in FIG. 1B passing through the center of curvature Cl of the first optical structure 222a is taken as an example.

Since the stereoscopic display system 100 of the present embodiment is complied with that p₂ is substantially equal to (1+d/D)p₁, the partial beams 112a1, 112b1 and 112c1 projected to the positions Q1, Q2 and Q3 are respectively guided to different directions by the second optical structure 232a, and after the partial beams 112a1-112a3, 112b1-112b3, or 112c1-112c3 (for example, the partial beams 112a1, 112a2 and 112a3) of the image beam 112a, 112b, or 112c (for example, the image beam 112a) projected by the same image projection apparatuses 110 (for example, the mage projection apparatus 110a) are respectively guided by the second optical structures 232 (for example, the second optical structures 232a, 232b and 232c), the partial beams 112a1-112a3, 112b1-112b3, or 112c1-112c3 (for example, the partial beams 112a1, 112a2 and 112a3) are substantially parallel to each other on at least one cross-section (for example, on any plane parallel to the figure plane of FIG. 1B, i.e. any plane perpendicular to the first direction D1). In detail, when the stereoscopic display system 100 is complied with p₂ is substantially equal to (1+d/D)p₁, a distance between the position Q1 and a position Q4 where the partial beam 112a2 is projected on the optical diffusion layer 210 is substantially equal to a distance between a center of curvature C2 of a cylindrical surface 233 of the second optical structure 232a and the center of curvature C2 of the cylindrical surface 233 of the second optical structure 232b (i.e. the pitch p₂), so that a connection line between the position Q1 and the center of curvature C2 of the cylindrical surface 233 of the second optical structure 232a is substantially parallel to a connection line between the position Q4 and the center of curvature C2 of the cylindrical surface 233 of the second optical structure 232b. Therefore, after the partial beams 112a1, 112a2 and 112a3 of the image beam 112a projected by the same image projection apparatus 110a are respectively guided by the second optical structures 232a, 232b and 232c, the partial beams 112a1, 112a2 and 112a3 are substantially parallel to each other on at least one cross-section (for example, on any plane parallel to the figure plane of FIG. 1B, i.e. any plane perpendicular to the first direction D1), so do the partial beams 112b1, 112b2 and 112b3 of the image beam 112b projected by the same image projection apparatus 110b, and so do the partial beams 112c1, 112c2 and 112c3 of the image beam 112c projected by the same image projection apparatus 110c, though the partial beams 112a1-112a3, 112b1-112b3 and 112c1-112c3 of the image beams 112a, 112b and 112c projected by different image projection apparatuses 110a, 110b and 110c are respectively guided to different directions by the second optical structures 232a, 232b and 232c. In other words, the final directions of the partial beams 112a1-112a3, 112b1-112b3, or 112c1-112c3 of the image beam 112a, 112b, or 112c projected by one image projection apparatus 110 that are guided by the second optical structures 232a, 232b and 232c are determined by the position of the outlet, where the image projection apparatus 110 projects the image beam 112a, 112b, or 112c, along the second direction D2. Moreover, in the present embodiment, each of the partial beams 112a1-112a3, 112b1-112b3, and 112c1-112c3 may be divergent along the first direction D1.

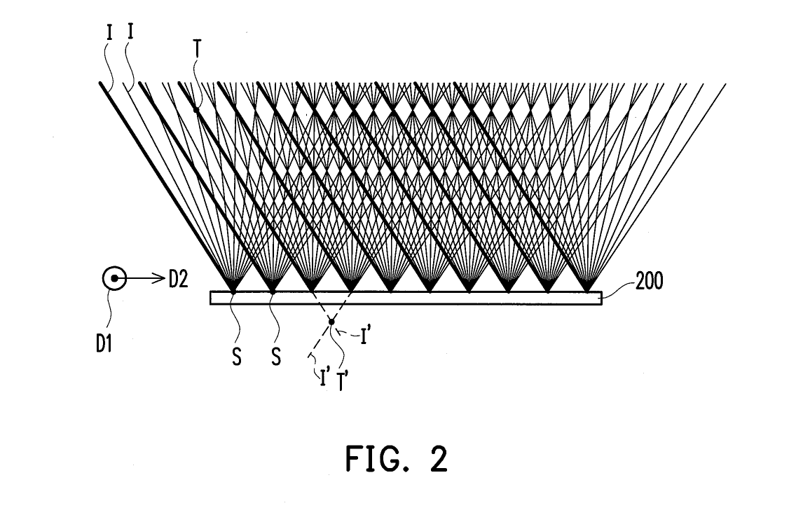

FIG. 2 is a schematic diagram of numerous light beams formed in space by the stereoscopic display system of FIG. 1. Referring to FIG. 1A, FIG. 1B and FIG. 2, when the image projection apparatuses 110 simultaneously project the light beams to the screen module 200, each of the second optical structures 232 of the second image guiding plate 230 can produce a plurality of light beams I with different propagating directions, where each of the light beams I comes from one image projection apparatus 110, and each of start points S on the screen module 200 of FIG. 2 that sends the light beams I is the second optical structure 232. In FIG. 2, the light beams I of thick lines come from the same image projection apparatus 110, and theses light beams I are substantially parallel to each other on any cross-section perpendicular to the first direction D1. In other words, the light beams I that are substantially parallel to each other on any cross-section perpendicular to the first direction D1 come from the same image projection apparatus 110. The greater the number of the image projection apparatuses 110 is, the higher density the light beams I are, and a plurality of intersections T of the light beams I are formed in front of the screen module 200. Virtual lines I′ formed by the light beams I extending to the back of the screen module 200 can also form a plurality of intersections T′ at the back of the screen module 200, and the intersections T and T′ can be used to form virtual light spots of an object surface, and a plurality of the virtual light spots can form the object to be displayed.

When a left eye and a right eye of a user are aligned to be about parallel to the second direction D2, regardless of the position where the user locates in front of the screen module 200, the user may regard that the position of the object to be displayed by the stereoscopic display system 100 falls on the light spots located in front of or at the back of the screen module 200. Since the positions of the light spots are not changed along with the position of the user, when the user is located at a different position, the user does not feel a position variation of the displayed object. In this way, the stereoscopic display system 100 can present the same stereoscopic display quality to the users located at different viewing positions. Moreover, since the stereoscopic display system 100 does not produce the stereoscopic images according to the conventional multi-viewing zone principle, the stereoscopic display system 100 of the present embodiment is different from the conventional stereoscopic display whose user needs to locate at an optimal viewing distance in order to view good stereoscopic images. In other words, the stereoscopic display system 100 of the present embodiment is not limited by the conventional optimal viewing distance, i.e. the viewing position and the viewing distance of the user are not limited. In this way, the user can arbitrarily move in front of the screen module 200 and can still have a good stereoscopic viewing effect.

In the present embodiment, the optical diffusion layer 210 falls approximately on a focal plane of the first optical structures 222 (i.e. the lenticular lenses), and the optical diffusion layer 210 falls approximately on a focal plane of the second optical structures 232 (i.e. the lenticular lenses). When the optical diffusion layer 210 just falls on the focal planes of the first optical structures 222 and the second optical structures 232, a relative correct and good stereoscopic display effect is achieved, though if the number of the image projection apparatuses 110 is inadequate, the user may feel discontinuity of the displayed stereoscopic image, for example, discontinuity between the position Q1 and the position Q2 is liable to be perceived by the user. In order to mitigate such problem, the optical diffusion layer 210 is designed not to just fall on the focal plane of the first optical structures 222, instead, the optical diffusion layer 210 is designed to fall at a place a little bit ahead of or behind the focal plane of the first optical structures 222. In this way, the light spots projected to the position Q1 and the position Q2 are slightly out of focus to have a larger size, so that the position Q1 and the position Q2 look more continuous, and the user may feel a continuous and even displayed stereoscopic image. Similarly, the optical diffusion layer 210 is designed not to just fall on the focal plane of the second optical structures 232, in stead, the optical diffusion layer 210 is designed to fall at a place a little bit ahead of or behind the focal plane of the second optical structures 232, so that the displayed stereoscopic image can be continuous and even. In an embodiment, the optical diffusion layer 210 is designed not to just fall on the focal planes of the first optical structure 222 and the second optical structures 232, simultaneously. In the present embodiment, a distance between the optical diffusion layer 210 and the focal plane of the first optical structures 222 is, for example, smaller than ¼ of a focal length of the first optical structure 222, and a distance between the optical diffusion layer 210 and the focal plane of the second optical structures 232 is, for example, smaller than ¼ of a focal length of the second optical structure 232, and in such range, the stereoscopic display effects of the stereoscopic images are all acceptable, and the designer or the user can determine values used in such range according to demands of the image evenness and the stereoscopic display effect.

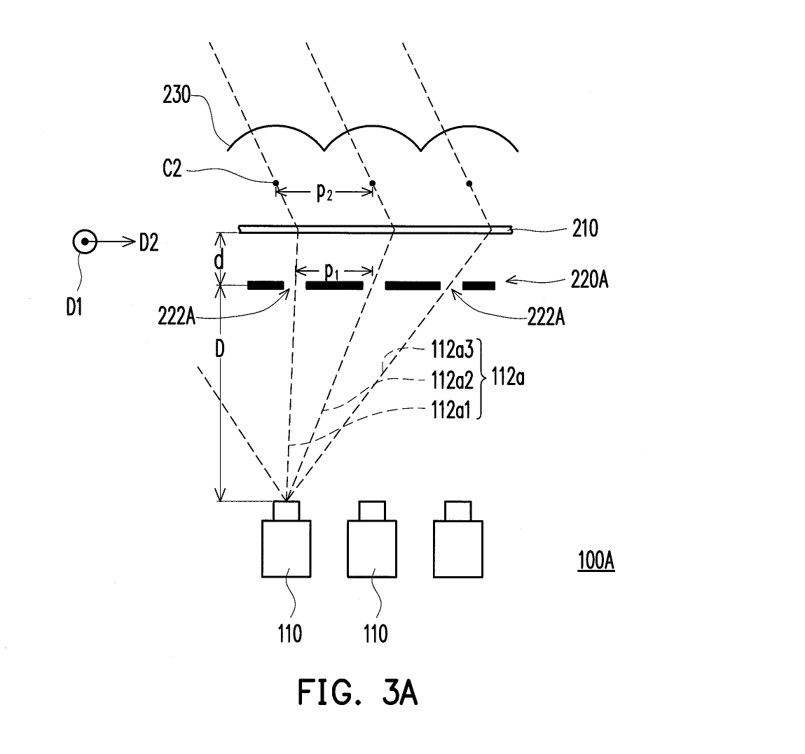

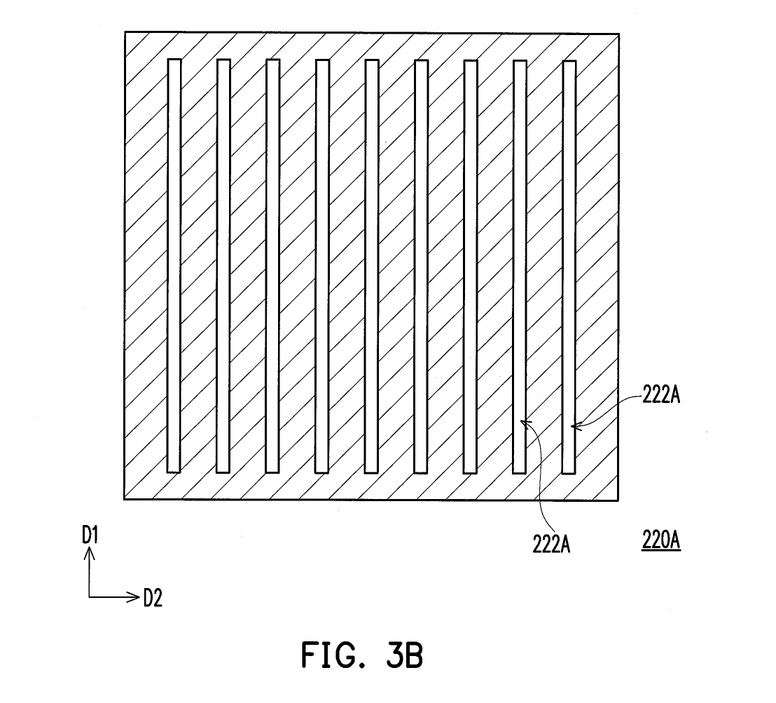

FIG. 3A is a partial top view of a stereoscopic display system according to another exemplary embodiment. FIG. 3B is a front view of a first image guiding plate of FIG. 3A. Referring to FIG. 3A and FIG. 3B, the stereoscopic display system 100A of the present embodiment is similar to the stereoscopic display system 100 of FIG. 1B, and differences therebetween are as follows. In the present embodiment, a first image guiding plate 220A is a grating, and each of first optical structures 222A is a slit, where each of the slits extends along the first direction D1, and the slits are arranged along the second direction D2. In the present embodiment, the first direction D1 is substantially perpendicular to the second direction D2. However, in other embodiments, the first direction D1 can be non-perpendicular to the second direction D2. The slits of the grating are pervious to the light, and a portion of the grating other than the slits can block the light. In the present embodiment, a pitch of the slit is p₁, a distance between each slit and the optical diffusion layer 210 is d, a distance between the image projection apparatuses 110 and the slits along a direction perpendicular to the optical diffusion layer 210 is D, and p₂ is substantially equal to (1+d/D)p₁. In the present embodiment, the slits are located at the centers of curvature C1 of FIG. 1B, and according to principles of optics, since an effect that the partial beams 112a1-112a3, 112b1-112b3 and 112c1-112c3 of the image beams 112a, 112b and 112c sent by the image projection apparatuses 110 pass through the slits is similar to the effect that the partial beams 112a1-112a3, 112b1-112b3 and 112c1-112c3 of FIG. 1B pass through the centers of curvature C1, the first image guiding plate 220A can also project the partial beams 112a1-112a3, 112b1-112b3 and 112c1-112c3 of the image beams 112a, 112b and 112c sent by the different image projection apparatuses 110 to different positions on the optical diffusion layer 210. Therefore, the stereoscopic display system 100A of the present embodiment also has the same effects as that of the stereoscopic display system 100 of FIG. 1B, which are not repeated. In other embodiments, the stereoscopic display system 100A is also substantially complied with p₂=N(1+d/D)p₁, or is substantially complied with p₂=(1+d/D)p₁/N, where N is a positive integer.

In the present embodiment, the first image guiding means can be implemented by the first image guiding plate 220A, the optical diffusion means can be implemented by the optical diffusion layer 210, and the second image guiding means can be implemented by the second image guiding plate 230.

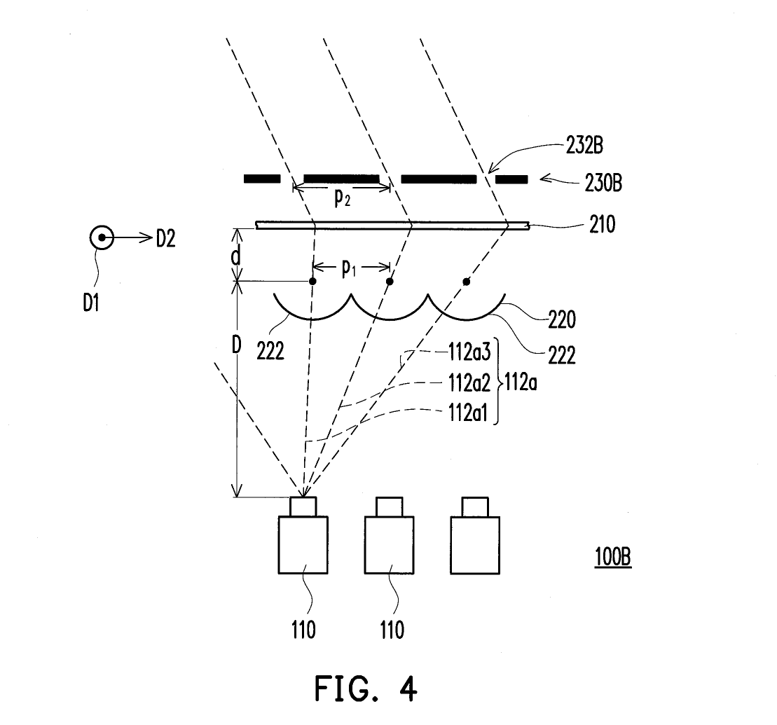

FIG. 4 is a partial top view of a stereoscopic display system according to still another exemplary embodiment. Referring to FIG. 4, the stereoscopic display system 100B of the present embodiment is similar to the stereoscopic display system 100 of FIG. 1B, and differences therebetween are as follows. In the present embodiment, a second image guiding plate 230B is a grating, and each of second optical structures 232B is a slit, where each of the slits extends along the first direction D1, and the slits are arranged along the second direction D2. In the present embodiment, the first direction D1 is substantially perpendicular to the second direction D2. However, in other embodiments, the first direction D1 can be non-perpendicular to the second direction D2. The slits of the grating are pervious to the light, and a portion of the grating other than the slits can block the light. In the present embodiment, a pitch of the slit is p₂, and p₂ is substantially equal to (1+d/D)p₁. In the present embodiment, the slits are located at the centers of curvature C2 of FIG. 1B, and according to principles of optics, since an effect that the partial beams 112a1-112a3, 112b1-112b3 and 112c1-112c3 of the image beams 112a, 112b and 112c sent by the image projection apparatuses 110 pass through the slits is similar to the effect that the partial beams 112a1-112a3, 112b1-112b3 and 112c1-112c3 of FIG. 1B pass through the centers of curvature C2, the second image guiding plate 230B can guide the image beams 112a, 112b and 112c projected on the optical diffusion layer 210 by the different image projection apparatuses 110 to different directions, and after the partial beams 112a1-112a3, 112b1-112b3, or 112c1-112c3 of the image beam 112a, 112b, or 112c projected by the same image projection apparatus 110 are respectively guided by the second optical structures 232B, the partial beams 112a1-112a3, 112b1-112b3, or 112c1-112c3 are substantially parallel to each other on at least one cross-section. Therefore, the stereoscopic display system 100B of the present embodiment also has the same effects as that of the stereoscopic display system 100 of FIG. 1B, which are not repeated. In other embodiments, the stereoscopic display system 100B is also substantially complied with p₂=N(1+d/D)p₁, or is substantially complied with p2=(1+d/D)p₁/N, where N is a positive integer.

In the present embodiment, the first image guiding means can be implemented by the first image guiding plate 220, the optical diffusion means can be implemented by the optical diffusion layer 210, and the second image guiding means can be implemented by the second image guiding plate 230B.

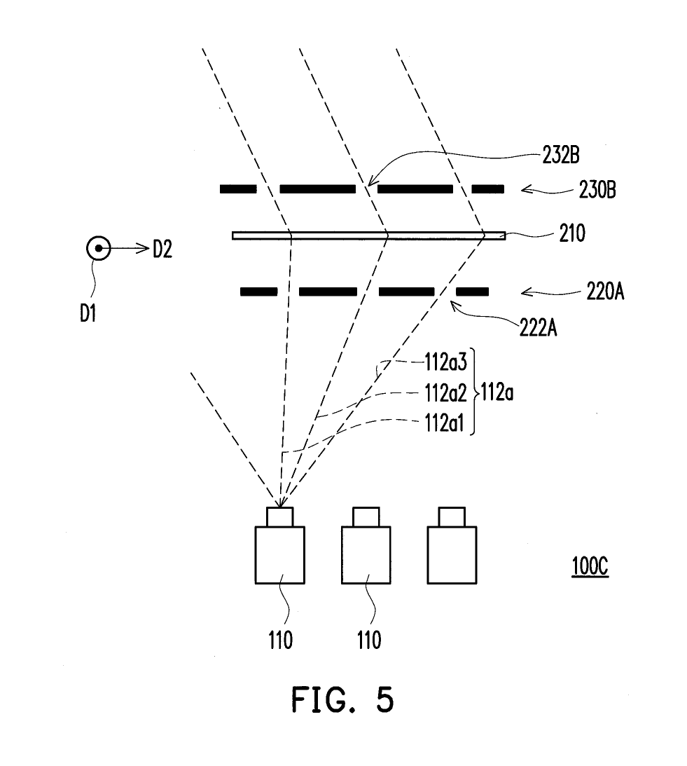

FIG. 5 is a partial top view of a stereoscopic display system according to yet another exemplary embodiment. Referring to FIG. 5, the stereoscopic display system 100C of the present embodiment is similar to the stereoscopic display system 100 of FIG. 1B, and differences therebetween are as follows. In the stereoscopic display system 100C of the present embodiment, the first image guiding plate 220A (i.e. the grating) of FIG. 3A is used to replace the first image guiding plate 220 (i.e. the lenticular plate) of FIG. 1B, and meanwhile the second image guiding plate 230B (i.e. the grating) of FIG. 4 is used to replace the second image guiding plate 230 (i.e. the lenticular plate) of FIG. 1B. Optical effects of the first image guiding plate 220A and the second image guiding plate 230B are as that described in the embodiments of FIG. 3A and FIG. 4, which are not repeated. In the present embodiment, a pitch of the first image guiding plate 220A is p₁, a pitch of the second image guiding plate 230B is p₂, and p₂ is substantially equal to (1+d/D)p₁. Moreover, the stereoscopic display system 100C of the present embodiment also has the same effects as that of the stereoscopic display system 100 of FIG. 1B, which are not repeated. In other embodiments, the stereoscopic display system 100C is also substantially complied with p₂=N(1+d/D)p₁, or is substantially complied with p₂=(1+d/D)p₁/N, where N is a positive integer.

In the present embodiment, the first direction D1 is substantially perpendicular to the second direction D2. However, in other embodiments, the first direction D1 can be non-perpendicular to the second direction D2.

In the present embodiment, the first image guiding means can be implemented by the first image guiding plate 220A, the optical diffusion means can be implemented by the optical diffusion layer 210, and the second image guiding means can be implemented by the second image guiding plate 230B.

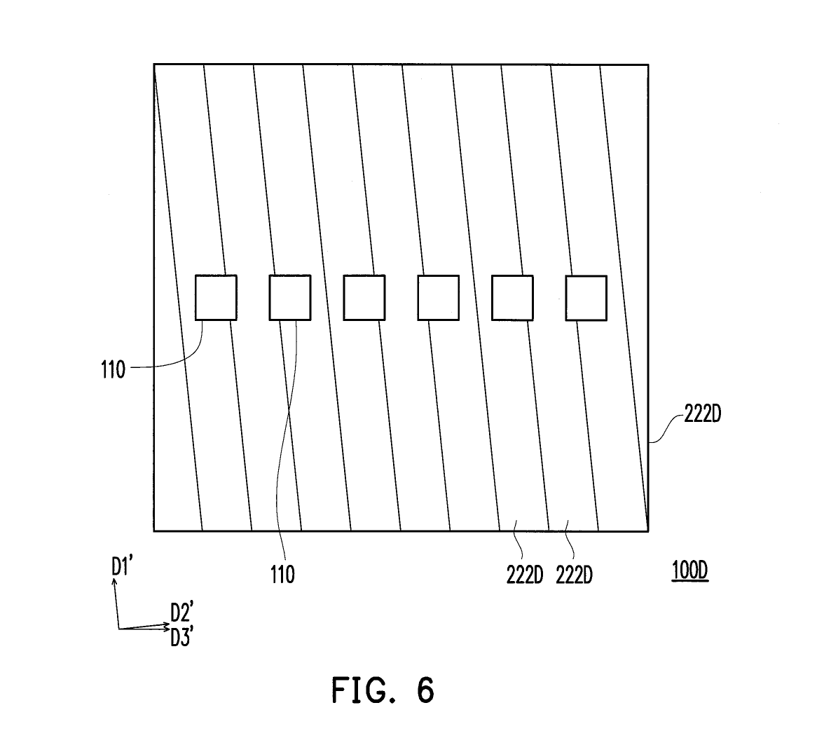

FIG. 6 is a back view of a stereoscopic display system according to another exemplary embodiment. Referring to FIG. 6, the stereoscopic display system 100D of the present embodiment is similar to the stereoscopic display system 100 of FIG. 1B, and differences therebetween are as follows. In the stereoscopic display system 100D of the present embodiment, an arranging direction (i.e. a third direction D3′ shown in FIG. 6) of the image projection apparatuses 110 is oblique to a direction (i.e. a second direction D2′) along which first optical structures 222D of a first image guiding plate 220D present periodicity. In detail, each of the first optical structures 222D extends along a first direction D1′, and the first optical structures 222D are arranged along the second direction D2′, where the first direction D1′ is substantially perpendicular to the second direction D2′. However, in other embodiments, the first direction D1′ can be non-perpendicular to the second direction D2′. Moreover, in the present embodiment, the arranging direction (i.e. the third direction D3′) of the image projection apparatuses 110 is also oblique to the extending direction (i.e. the first direction D1′) of the first optical structures 222D. In addition, in the present embodiment, a direction along which the second optical structures of the second image guiding plate (located at a backside of the first image guiding plate 220D, which is not illustrated) present periodicity is also the second direction D2′, each of the second optical structures extends along the first direction D1′, and the second optical structures are arranged along the second direction D2′. The stereoscopic display system 100D of the present embodiment also has the same effects as that of the stereoscopic display system 100 of FIG. 1B, which are not repeated.

In the present embodiment, the arranging direction and the extending direction of the lenticular lenses (including the first optical structures 222D and the second optical structures) are oblique to the arranging direction of the image projection apparatuses 110. However, in other embodiments, when the first image guiding plate is a grating, an arranging direction and an extending direction of the slits of the first image guiding plate are oblique to the arranging direction of the image projection apparatuses 110. Moreover, when the second image guiding plate is a grating, an arranging direction and an extending direction of the slits of the second image guiding plate are oblique to the arranging direction of the image projection apparatuses 110.

In the present embodiment, the first image guiding plate 220D and the second image guiding plate are, for example, lenticular plates, though in other embodiments, at least one of the first image guiding plate 220D and the second image guiding plate can be replaced by a grating, and each slit of the grating extends along the first direction D1′, and the slits of the grating are arranged along the second direction D2′.

Moreover, in the present embodiment, a pitch of the first optical structures 222D is, for example, p₁, a pitch of the second optical structures is, for example, p₂, a distance between the first optical structures 222D and the optical diffusion layer 210 is d, a distance between the image projection apparatuses 110 and the first optical structures 222D along a direction perpendicular to the optical diffusion layer 210 is D, and the stereoscopic display system 100D of the present embodiment is substantially complied with p₂=N(1+d/D)p₁, or is substantially complied with p₂(1+d/D)p₁/N, where N is a positive integer.

In the present embodiment, the first image guiding means can be implemented by the first image guiding plate having the oblique first optical structures 222D, the optical diffusion means can be implemented by the optical diffusion layer, and the second image guiding means can be implemented by the second image guiding plate having the oblique second optical structures.

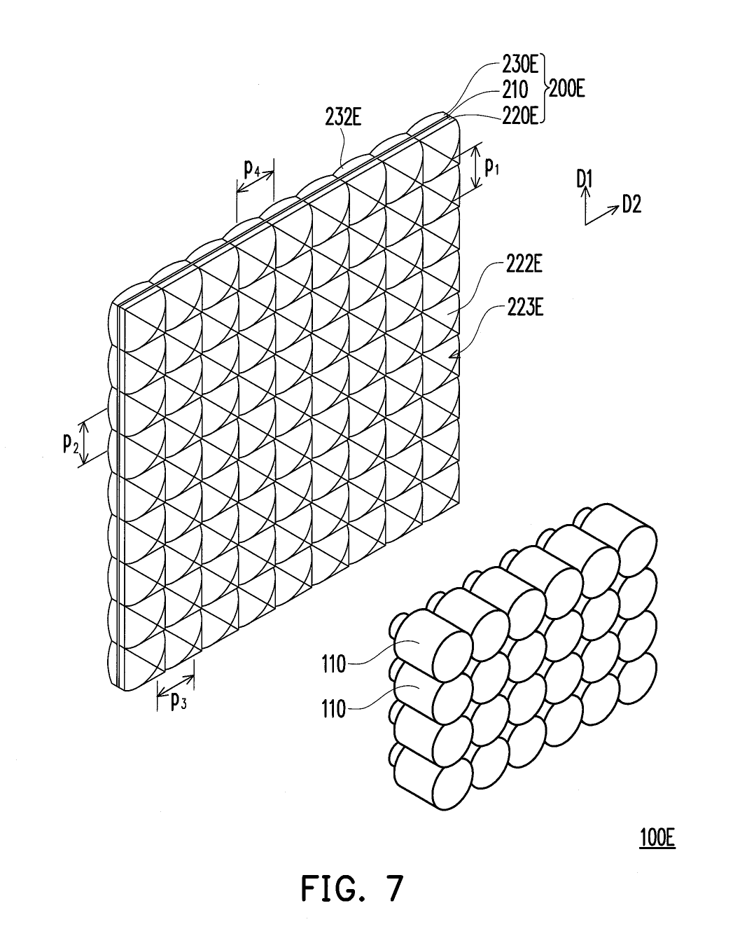

FIG. 7 is a three-dimensional view of a stereoscopic display system according to still another exemplary embodiment. Referring to FIG. 7, the stereoscopic display system 100E of the present embodiment is similar to the stereoscopic display system 100 of FIG. 1B, and differences therebetween are as follows. In the stereoscopic display system 100E of the present embodiment, after a plurality of different partial beams of the image beam projected by the same image projection apparatus 110 are guided by the second image guiding means, the partial beams are substantially parallel to each other. In the present embodiment, the first image guiding means can be implemented by a first image guiding plate 220E of a screen module 200E, the optical diffusion means can be implemented by the optical diffusion layer 210, and the second image guiding means can be implemented by a second image guiding plate 230E of the screen module 200E.

In the present embodiment, first optical structures 222E of the first image guiding plate 220E present periodicity in two dimensions, second optical structures 232E of the second image guiding plate 230E present periodicity in two dimensions, and the image projection apparatuses 110 are arranged in a two-dimensional array. Moreover, after a plurality of different partial beams of the image beam projected by the same image projection apparatus 110 are respectively guided by the second optical structures 232E, the partial beams are substantially parallel to each other.

In detail, in the present embodiment, the first optical structures 222E of the first image guiding plate 220E not only has a pitch p₁ along the first direction D1, but also has a pitch p₃ along the second direction D2. Moreover, the second optical structures 232E of the second image guiding plate 230E not only has a pitch p₂ along the first direction D1, but also has a pitch p₄ along the second direction D2, where the pitch p₂ is greater than the pitch p₁, and the pitch p₄ is greater than the pitch p₃. In the present embodiment, image projection apparatuses 110 are arranged in a two-dimensional array along the first direction D1 and the second direction D2. In the present embodiment, the first direction D1 is substantially perpendicular to the second direction D2. However, in other embodiments, the first direction D1 can be non-perpendicular to the second direction D2. In the present embodiment, p₂ is substantially equal to (1+d/D)p₁, and p₄ is substantially equal to (1+d/D)p₃. In other embodiments, the stereoscopic display system 100E of the present embodiment is substantially complied with p₂=N(1+d/D)p₁, or is substantially complied with p2=(1+d/D)p₁/N, where N is a positive integer. Moreover, in other embodiments, the stereoscopic display system 100E is substantially complied with p₄=N′(1+d/D)p₃, or is substantially complied with p₄=(1+d/D)p₃/N′, where N′ is a positive integer.

In the present embodiment, the first image guiding plate 220E is, for example, a lens array plate, each of the first optical structures 222E is a lens, and the lenses are arranged in a two-dimensional array. Moreover, the second image guiding plate 230E is, for example, a lens array plate, each of the second optical structures 232E is a lens, and the lenses are arranged in a two-dimensional array. In the present embodiment, each of the first optical structures 222E (i.e. the lens) has a spherical surface 223E, a distance between a center of curvature of each spherical surface 223E and the optical diffusion layer 210 is d, a distance between the image projection apparatuses 110 and the center of curvature of the spherical surfaces 223E along a direction perpendicular to the optical diffusion layer 210 is D, where p₂ is substantially equal to (1+d/D)p₁, and p₄ is substantially equal to (1+d/D)p₃.

Moreover, in the present embodiment, the optical diffusion layer 210 falls approximately on a focal plane of the first optical structures 222E (i.e. the lenses). Moreover, the optical diffusion layer 210 falls approximately on a focal plane of the second optical structures 232E (i.e. the lenses).

In other words, a cross-section perpendicular to the second direction D2 and a cross-section perpendicular to the first direction D1 of the stereoscopic display system 100E of the present embodiment are the same as that shown in FIG. 1B. Therefore, after the partial beams of the image beam projected by the same image projection apparatus 110 are respectively guided by the second optical structures 232E, the partial beams are substantially parallel to each other, namely, the partial beams are not only parallel to each other on any cross-section perpendicular to the second direction D2, but also parallel to each other on any cross-section perpendicular to the first direction D1. In this way, when the user's left eye and right eye are approximately aligned along the first direction D1, the user can view the stereoscopic images. Moreover, when the user's left eye and the right eye are approximately aligned along the second direction D2, the user can also view the stereoscopic images.

In other embodiments, the arranging direction of the lenses (including the first optical structures 222E and the second optical structures 232E) can also be oblique to the arranging direction of the image projection apparatuses 110.

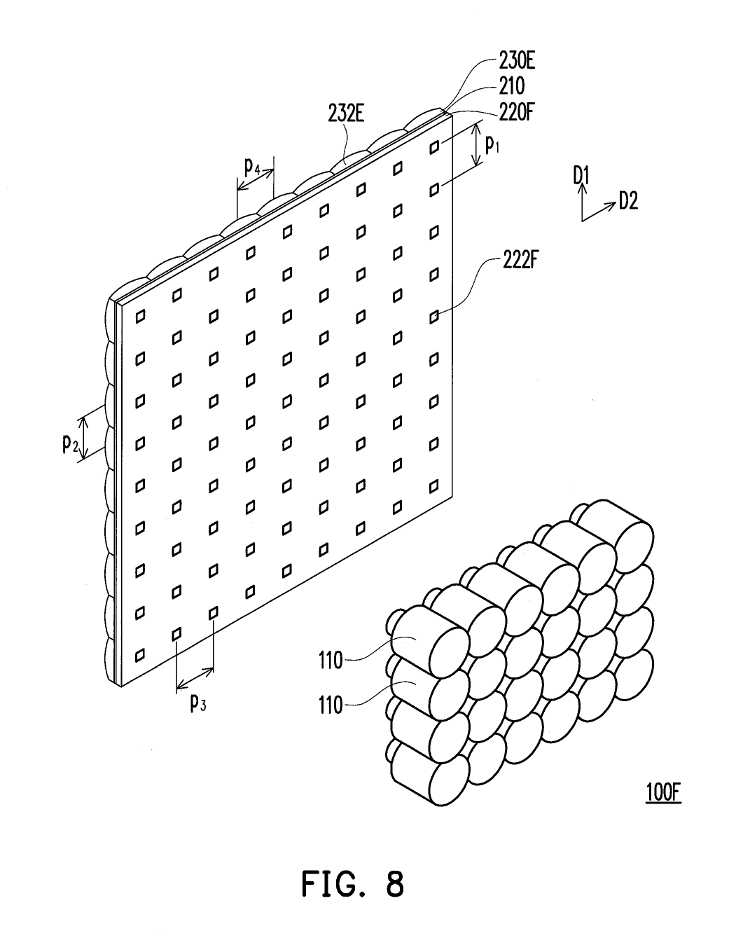

FIG. 8 is a three-dimensional view of a stereoscopic display system according to still another exemplary embodiment. Referring to FIG. 8, the stereoscopic display system 100F of the present embodiment is similar to the stereoscopic display system 100E of FIG. 7, and differences therebetween are as follows. In the present embodiment, the first image guiding plate 220F is, for example, a pinhole array plate, and each of first optical structures 222F is a pinhole, where the pinholes are arranged in a two-dimensional array. The pinholes of the pinhole array plate are pervious to light, and a portion of the pinhole array plate other than the pinholes can block the light. A pitch of the pinholes along the first direction D1 is p₁, a pitch of the second optical structures 232E along the first direction D1 is p₂, a distance between each pinhole and the optical diffusion layer 210 is d, a distance between the image projection apparatuses 110 and the pinholes along a direction perpendicular to the optical diffusion layer 210 is D, and p₂ is substantially equal to (1+d/D)p₁. Moreover, in the present embodiment, a pitch of the pinholes along the second direction D2 is p₃, and a pitch of the second optical structures 232E along the second direction D2 is p₄, where p₄ is substantially equal to (1+d/D)p₃. In the present embodiment, the first direction D1 is substantially perpendicular to the second direction D2. However, in other embodiments, the first direction D1 can be non-perpendicular to the second direction D2. In the present embodiment, the pinholes are located at centers of spheres of the first optical structures 222E (i.e. the lenses) of FIG. 7. In other embodiments, the stereoscopic display system 100F is also substantially complied with p₂=N(1+d/D)p₁, or is substantially complied with p₂=(1+d/D)p₁/N, where N is a positive integer. Moreover, in other embodiments, the stereoscopic display system 100F is also substantially complied with p₄=N′(1+d/D)p₃, or is substantially complied with p4=(1+d/D)p₃/N′, where N′ is a positive integer.

A cross-section perpendicular to the second direction D2 and a cross-section perpendicular to the first direction D1 of the stereoscopic display system 100F of the present embodiment are the same as that shown in FIG. 3A. Therefore, after the partial beams of the image beam projected by the same image projection apparatus 110 are respectively guided by the second optical structures 232E, the partial beams are substantially parallel to each other, namely, the partial beams are not only parallel to each other on any cross-section perpendicular to the second direction D2, but also parallel to each other on any cross-section perpendicular to the first direction D1. In this way, when the user's left eye and right eye are approximately aligned along the first direction D1, the user can view the stereoscopic images. Moreover, when the user's left eye and the right eye are approximately aligned along the second direction D2, the user can also view the stereoscopic images.

In another embodiment, the second image guiding plate 230E (i.e. the lenticular plate) of FIG. 7 can also be replaced by a pinhole array plate, i.e. each of the second optical structures is a pinhole, where the pinholes are arranged in a two-dimensional array. In the present embodiment, a pitch of the pinholes along the first direction D1 is p₂, and a pitch of the pinholes along the second direction D2 is p₄, P2 is substantially equal to (1+d/D)p₁, and p₄ is substantially equal to (1+d/D)p₃. Moreover, in another embodiment, the first image guiding plate 220E and the second image guiding plate 230E of FIG. 7 can be simultaneously replaced by the pinhole array plates.

In the present embodiment, the arranging direction of the pinholes (the first optical structures 222F) is in accordance with the arranging direction of the image projection apparatuses 110. However, in other embodiments, the arranging direction of the pinholes (the first optical structures 222F) can be oblique to the arranging direction of the image projection apparatuses 110. Moreover, when the pinhole array plate is used to replace the second image guiding plate 230E, an arranging direction of the pinholes of such pinhole array plate can be in accordance with the arranging direction of the image projection apparatuses 110, or the arranging direction of the pinholes of such pinhole array plate can be oblique to the arranging direction of the image projection apparatuses 110.

In the present embodiment, the first image guiding means can be implemented by the first image guiding plate 220F, the optical diffusion means can be implemented by the optical diffusion layer 210, and the second image guiding means can be implemented by the second image guiding plate 230E.

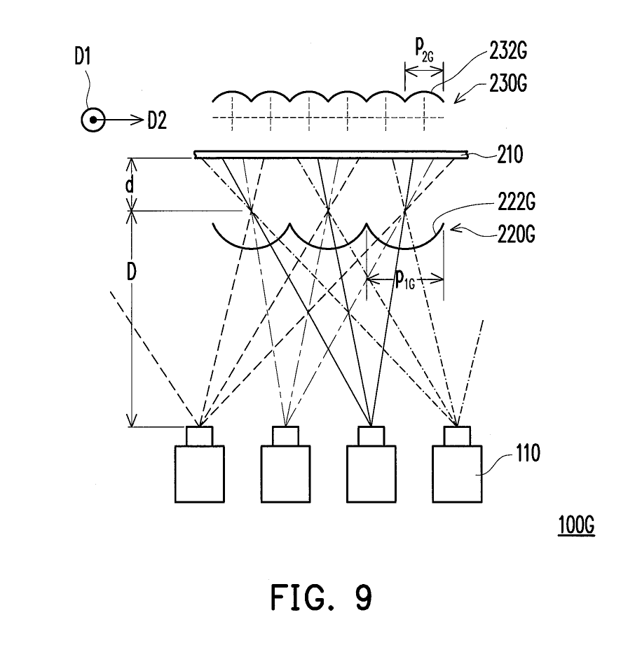

FIG. 9 is a partial top view of a stereoscopic display system according to still another exemplary embodiment. Referring to FIG. 9, the stereoscopic display system 100G of the present embodiment is similar to the stereoscopic display system 100 of FIG. 1B, and differences therebetween are as follows. In the stereoscopic display system 100G of the present embodiment, a relationship between a pitch p_{1G} of first optical structures 222G of a first image guiding plate 220G and a pitch p_{2G} of second optical structures 232G of a second image guiding plate 230G is substantially complied with a following equation:

Np_{2G}=(1+d/D)p_{1G}

where N is a positive integer, and in the present embodiment, N=2 is taken as an example, though in an actual application, N can be any positive integer. According to such structure, in case of the same number of the image projection apparatuses 110, the amount of light emitted from the second optical structures 232G of the second image guiding plate 230G can be reduced to 1/N times, though N times image resolution is produced, namely, design flexibility is provided in case of a fixed value of a multiplication of the number of the image projection apparatuses 110, the amount of light and the image resolution.

In the present embodiment, the first image guiding means can be implemented by the first image guiding plate 220G, the optical diffusion means can be implemented by the optical diffusion layer 210, and the second image guiding means can be implemented by the second image guiding plate 230G.

In the present embodiment, an extending direction (i.e. the first direction D1) of the first optical structures 222G and the second optical structures 232G is substantially perpendicular to an arranging direction (i.e. the second direction D2) of the first optical structures 222G and the second optical structures 232G. However, in other embodiments, the first direction D1 can be non-perpendicular to the second direction D2.

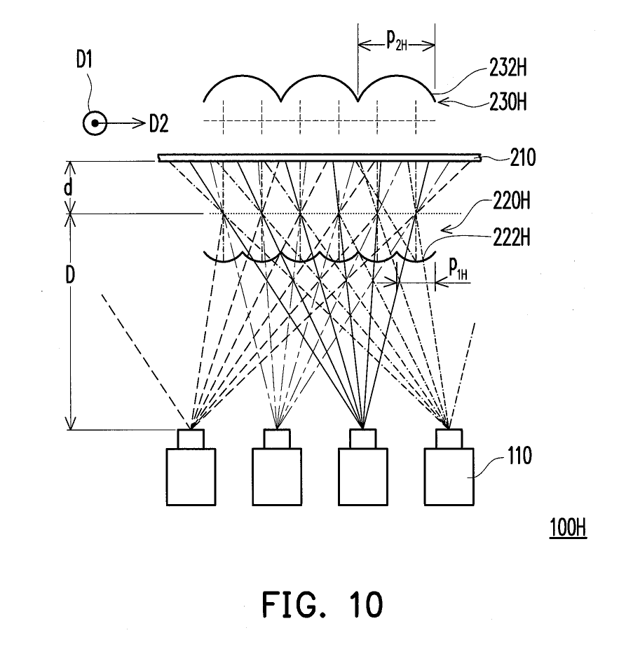

FIG. 10 is a partial top view of a stereoscopic display system according to still another exemplary embodiment. Referring to FIG. 10, the stereoscopic display system 100H of the present embodiment is similar to the stereoscopic display system 100 of FIG. 1B, and differences therebetween are as follows. In the stereoscopic display system 100H of the present embodiment, a relationship between a pitch p_{1H} of first optical structures 222H of a first image guiding plate 220H and a pitch p_{2H} of second optical structures 232H of a second image guiding plate 230H is substantially complied with a following equation:

p_{2H}=N(1+d/D)p_{1H}

where N is a positive integer, and in the present embodiment, N=2 is taken as an example, though in an actual application, N can be any positive integer. According to such structure, in case of the same number of the image projection apparatuses 110, the image resolution is reduced to 1/N times, so that the amount of light emitted from the second optical structures 232H of the second image guiding plate 230H can be increased to N times, namely, design flexibility of another direction is provided in case of a fixed value of the multiplication of the number of the image projection apparatuses 110, the amount of light and the image resolution.

In the present embodiment, the first image guiding means can be implemented by the first image guiding plate 220H, the optical diffusion means can be implemented by the optical diffusion layer 210, and the second image guiding means can be implemented by the second image guiding plate 230H.

In the present embodiment, an extending direction (i.e. the first direction D1) of the first optical structures 222H and the second optical structures 232H is substantially perpendicular to an arranging direction (i.e. the second direction D2) of the first optical structures 222H and the second optical structures 232H. However, in other embodiments, the first direction D1 can be non-perpendicular to the second direction D2.

Moreover, the pitch relationship of the embodiment of FIG. 9 and FIG. 10 can also be applied to the relationship of the pitch p₃ and the pitch p₄, namely, Np₄ is substantially equal to (1+d/D)p₃, or p₄ is substantially equal to N(1+d/D)p₃, where N is a positive integer.

In summary, in the stereoscopic display system according to the embodiments of the disclosure, since the image beams come from different image projection apparatuses are respectively guided to different directions, and a plurality of the different partial beams of the image beam projected by the same image projection apparatus are substantially parallel to each other on at least one cross-section, the partial beams of the image beams can form a plurality of virtual light spots in front of or at the back of the screen module, and the virtual light spots can form the object to be displayed. In this way, the stereoscopic display system according to the embodiments of the disclosure can display stereoscopic images, and since the positions of the light spots are not changed along with the position of the user, when the user is located at a different position, the user does not feel a position variation of the displayed object. In this way, the stereoscopic display system according to the embodiments of the disclosure can present the same stereoscopic display quality to the users located at different viewing positions. Moreover, since the stereoscopic display system according to the embodiments of the disclosure does not use the conventional multi-viewing zone principle, the stereoscopic display system, is not limited by the conventional optimal viewing distance. Therefore, besides more users can simultaneously view the stereoscopic image displayed by the stereoscopic display system, the user can arbitrarily move in front of the screen module and can still have a good stereoscopic viewing effect. In addition, in the screen module according to the embodiments of disclosure, since the pitch of the second optical structures is greater than the pitch of the first optical structures, the stereoscopic images can be produced.

It will be apparent to those skilled in the art that various modifications and variations can be made to the disclosed embodiments. It is intended that the specification and examples be considered as exemplary only, with a true scope of the disclosure being indicated by the following claims and their equivalents.

What is claimed is:

1. A stereoscopic display system, comprising:
a plurality of image projection apparatuses, respectively projecting a plurality of image beams; and
a screen module, disposed on transmission paths of the image beams, and comprising:
an optical diffusion layer, disposed on the transmission paths of the image beams;
a first image guiding plate, disposed on the transmission paths of the image beams and between the image projection apparatuses and the optical diffusion layer, wherein the first image guiding plate comprises a plurality of first optical structures arranged in period for projecting the image beams to different positions on the optical diffusion layer; and
a second image guiding plate, disposed on the transmission paths of the image beams, wherein the optical diffusion layer is disposed between the first image guiding plate and the second image guiding plate, the second image guiding plate comprises a plurality of second optical structures arranged in period for respectively guiding the image beams projected on the optical diffusion layer by different image projection apparatuses to a plurality of different directions, and after a plurality of different partial beams of the image beam projected by the same image projection apparatus are respectively guided by the second optical structures, the partial beams are substantially parallel to each other on at least one cross-section.

2. The stereoscopic display system as claimed in claim 1, wherein a pitch of the second optical structures is greater than a pitch of the first optical structures.

3. The stereoscopic display system as claimed in claim 1, wherein a pitch of the first optical structures is p₁, a pitch of the second optical structures is p₂, a distance between the first optical structures and the optical diffusion layer is d, a distance between the image projection apparatuses and the first optical structures along a direction perpendicular to the optical diffusion layer is D, and p₂ is substantially equal to N(1+d/D)p₁ or substantially equal to (1+d/D)p₁/N, wherein N is a positive integer.

4. The stereoscopic display system as claimed in claim 3, wherein a pitch of the first optical structures along a first direction is p₁, a pitch of the second optical structures along the first direction is p₂, a pitch of the first optical structures along a second direction is p₃, a pitch of the second optical structures along the second direction is p₄, and p₄ is substantially equal to N(1+d/D)p₃ or substantially equal to (1+d/D)p₃/N, wherein N is a positive integer.

5. The stereoscopic display system as claimed in claim 1, wherein each of the first optical structures is a lenticular lens, each of the lenticular lenses extends along a first direction, and the lenticular lenses are arranged along a second direction.

6. The stereoscopic display system as claimed in claim 5, wherein a pitch of the lenticular lenses is p₁, a pitch of the second optical structures is p₂, each of the lenticular lenses has a cylindrical surface, a distance between a center of curvature of each of the cylindrical surfaces and the optical diffusion layer is d, a distance between the image projection apparatuses and the centers of curvature of the cylindrical surfaces along a direction perpendicular to the optical diffusion layer is D, and p₂ is substantially equal to N(1+d/D)pᵢ or substantially equal to (1+d/D)p₁/N, wherein N is a positive integer.

7. The stereoscopic display system as claimed in claim 5, wherein the optical diffusion layer falls approximately on a focal plane of the lenticular lenses.

8. The stereoscopic display system as claimed in claim 1, wherein each of the second optical structures is a lenticular lens, each of the lenticular lenses extends along a first direction, and the lenticular lenses are arranged along a second direction.

9. The stereoscopic display system as claimed in claim 8, wherein the optical diffusion layer falls approximately on a focal plane of the lenticular lenses.

10. The stereoscopic display system as claimed in claim 1, wherein the first image guiding plate is a grating, each of the first optical structures is a slit, each of the slits extends along a first direction, and the slits are arranged along a second direction.

11. The stereoscopic display system as claimed in claim 10, wherein a pitch of the slits is p₁, a pitch of the second optical structures is p₂, a distance between each of the slits and the optical diffusion layer is d, a distance between the image projection apparatuses and the slits along a direction perpendicular to the optical diffusion layer is D, and p₂ is substantially equal to N(1+d/D)p₁ or substantially equal to (1+d/D)p₁/N, wherein N is a positive integer.

12. The stereoscopic display system as claimed in claim 1, wherein the second image guiding plate is a grating, each of the second optical structures is a slit, each of the slits extends along a first direction, and the slits are arranged along a second direction.

13. The stereoscopic display system as claimed in claim 1, wherein each of the first optical structures is a lens, and the lenses are arranged in a two-dimensional array.

14. The stereoscopic display system as claimed in claim 13, wherein a pitch of the lenses along a first direction is p₁, a pitch of the second optical structures along the first direction is p₂, each of the lenses has a spherical surface, a distance between a center of curvature of each of the spherical surfaces and the optical diffusion layer is d, a distance between the image projection apparatuses and the centers of curvature of the spherical surfaces along a direction perpendicular to the optical diffusion layer is D, and p₂ is substantially equal to N(1+d/D)pᵢ or substantially equal to (1+d/D)p₁/N, wherein N is a positive integer.

15. The stereoscopic display system as claimed in claim 14, wherein a pitch of the lenses along a second direction is p₃, a pitch of the second optical structures along the second direction is p₄, and p₄ is substantially equal to N(1+d/D)p₃ or substantially equal to (1+d/D)p₃/N, wherein N is a positive integer.

16. The stereoscopic display system as claimed in claim 13, wherein the optical diffusion layer falls approximately on a focal plane of the lenses.

17. The stereoscopic display system as claimed in claim 1, wherein each of the second optical structures is a lens, and the lenses are arranged in a two-dimensional array.

18. The stereoscopic display system as claimed in claim 17, wherein the optical diffusion layer falls approximately on a focal plane of the lenses.

19. The stereoscopic display system as claimed in claim 1, wherein the first image guiding plate is a pinhole array plate, each of the first optical structures is a pinhole, and the pinholes are arrange in a two-dimensional array.

20. The stereoscopic display system as claimed in claim 19, wherein a pitch of the pinholes along a first direction is p₁, a pitch of the second optical structures along the first direction is p₂, a distance between each of the pinholes and the optical diffusion layer is d, a distance between the image projection apparatuses and the pinholes along a direction perpendicular to the optical diffusion layer is D, and p₂ is substantially equal to N(1+d/D)p₁ or substantially equal to (1+d/D)p₁/N, wherein N is a positive integer.

21. The stereoscopic display system as claimed in claim 20, wherein a pitch of the pinholes along a second direction is p₃, a pitch of the second optical structures along the second direction is p₄, and p₄ is substantially equal to N(1+d/D)p₃ or substantially equal to (1+d/D)p₃/N, wherein N is a positive integer.

22. The stereoscopic display system as claimed in claim 1, wherein the second image guiding plate is a pinhole array plate, each of the second optical structures is a pinhole, and the pinholes are arrange in a two-dimensional array.

23. The stereoscopic display system as claimed in claim 1, wherein a direction along which the first optical structures present periodicity is substantially the same to a direction along which the second optical structures present periodicity.

24. The stereoscopic display system as claimed in claim 23, wherein an arranging direction of the image projection apparatuses is substantially parallel to the direction along which the first optical structures present periodicity.

25. The stereoscopic display system as claimed in claim 23, wherein an arranging direction of the image projection apparatuses is oblique to the direction along which the first optical structures present periodicity.

26. The stereoscopic display system as claimed in claim 1, wherein the first optical structures present periodicity in two dimensions, the second optical structures present periodicity in two dimensions, the image projection apparatuses are arranged in a two-dimensional array, and after the different partial beams of the image beam projected by the same image projection apparatus are respectively guided by the second optical structures, the partial beams are substantially parallel to each other.

27. A screen module, comprising:
an optical diffusion layer;
a first image guiding plate, disposed at one side of the optical diffusion layer, and comprising a plurality of first optical structures arranged in period; and
a second image guiding plate, disposed at another side of the optical diffusion layer, wherein the optical diffusion layer is disposed between the first image guiding plate and the second image guiding plate, the second image guiding plate comprises a plurality of second optical structures arranged in period, and a pitch of the second optical structures is greater than a pitch of the first optical structures.

28. The screen module as claimed in claim 27, wherein each of the first optical structures is a lenticular lens, each of the lenticular lenses extends along a first direction, and the lenticular lenses are arranged along a second direction.

29. The screen module as claimed in claim 28, wherein the optical diffusion layer falls approximately on a focal plane of the lenticular lenses.

30. The screen module as claimed in claim 27, wherein each of the second optical structures is a lenticular lens, each of the lenticular lenses extends along a first direction, and the lenticular lenses are arranged along a second direction.

31. The screen module as claimed in claim 30, wherein the optical diffusion layer falls approximately on a focal plane of the lenticular lenses.

32. The screen module as claimed in claim 27, wherein the first image guiding plate is a grating, each of the first optical structures is a slit, each of the slits extends along a first direction, and the slits are arranged along a second direction.

33. The screen module as claimed in claim 27, wherein the second image guiding plate is a grating, each of the second optical structures is a slit, each of the slits extends along a first direction, and the slits are arranged along a second direction.

34. The screen module as claimed in claim 27, wherein each of the first optical structures is a lens, and the lenses are arranged in a two-dimensional array.

35. The screen module as claimed in claim 34, wherein the optical diffusion layer falls approximately on a focal plane of the lenses.

36. The screen module as claimed in claim 27, wherein each of the second optical structures is a lens, and the lenses are arranged in a two-dimensional array.

37. The screen module as claimed in claim 36, wherein the optical diffusion layer falls approximately on a focal plane of the lenses.

38. The screen module as claimed in claim 27, wherein the first image guiding plate is a pinhole array plate, each of the first optical structures is a pinhole, and the pinholes are arrange in a two-dimensional array.

39. The screen module as claimed in claim 27, wherein the second image guiding plate is a pinhole array plate, each of the second optical structures is a pinhole, and the pinholes are arrange in a two-dimensional array.

40. The screen module as claimed in claim 27, wherein a direction along which the first optical structures present periodicity is substantially the same to a direction along which the second optical structures present periodicity.

41. The screen module as claimed in claim 27, wherein a pitch of the second optical structures along a first direction is greater than a pitch of the first optical structures along the first direction, and a pitch of the second optical structures along a second direction is greater than a pitch of the first optical structures along the second direction.

42. A stereoscopic display system, comprising:
a plurality of image projection apparatuses, respectively projecting a plurality of image beams; and
a screen module, disposed on transmission paths of the image beams, and comprising:
first image guiding means for respectively projecting the image beams to different positions;
optical diffusion means for diffusing the image beams projected by the first image guiding means; and
second image guiding means for respectively guiding the image beams projected by different image projection apparatuses and diffused by the optical diffusion means to a plurality of different directions, wherein after a plurality of different partial beams of the image beam projected by the same image projection apparatus are guided by the second image guiding means, the partial beams are substantially parallel to each other on at least one cross-section.

43. The stereoscopic display system as claimed in claim 42, wherein after the different partial beams of the image beam projected by the same image projection apparatus are guided by the second image guiding means, the partial beams are substantially parallel to each other.
